(19) United States
(12) Patent Application Publication
(10) Pub. No.: US 2014/0019390 A1
(43) Pub. Date: Jan. 16, 2014

(54) APPARATUS AND METHOD FOR AUDIO FINGERPRINTING

(71) Applicant: UMAMI, CO., Glen Ridge, NJ (US)

(72) Inventors: Aron Glennon, New Windsor, NY (US); Eric Humphrey, Brooklyn, NY (US); Bryan Slavin, Rockville, MD (US); Scott Rosenberg, Glen Ridge, NJ (US)

(21) Appl. No.: 13/941,727

(22) Filed: Jul. 15, 2013

Related U.S. Application Data
(60) Provisional application No. 61/671,466, filed on Jul. 13, 2012.

(51) Int. Cl. G06N 5/02; G06N 99/00

(52) U.S. Cl. CPC G06N 5/02; G06N 99/005
USPC 706/12; 706/46

(57) ABSTRACT

Apparatus and method for fingerprinting an audio signal utilizes programmed machine to identify overlapping windows in a time domain representation of the audio signal, establish a frequency domain representation of the overlapping windows, convolve a set of two-dimensional kernels with the frequency domain representation to thereby provide a convolutional layer as an output stage, reduce dimensionality of the convolution layer to provide one or more further output stages, and perform further processing so as to output a decision in regard to a plurality of the overlapping windows comprising either a specific content id that matches to the audio signal or a failure-to-match indication.

This patent application claims the benefit of priority under 35 U.S.C. Section 119(e) of U.S. Provisional Application No. 61/671,466, filed Jul. 13, 2012, which is hereby incorporated by reference as if set forth in its entirety herein.

### FIELD OF THE INVENTION

The present invention relates to the processing of audio content and more particularly to methods and apparatus for generating audio fingerprints that enable fast, accurate searches across very large libraries of content.

### BACKGROUND OF THE INVENTION

There are a wide variety of consumer applications in which it is useful for a device or application to automatically identify what media a consumer is watching or listening to, including: displaying additional information about the program; allowing a consumer to get information about an advertisement; and measurement of viewing habits and behaviors.

One general approach, called “audio fingerprinting”, is to identify content based on its audio signal. Key features (or “fingerprints”) are extracted from a sample, then used to search a database of known content. Due to background noise and other distortions that might occur during sample collection, a sample's fingerprints often diverge greatly from the fingerprints associated with the original reference material in the database. Therefore, most often, such systems must be able to search for an approximate match.

Depending on the technique, a large number of data points (high dimensionality) may be required to represent a small segment of content. Unfortunately, traditional data structures used in search, such as B-trees, do not tend to work well for high-dimensional, approximate searches. Because the system must be resilient to numerous discrepancies between the sample and reference materials, in practice, many more comparisons must be made (relative to a traditional search system with little or no discrepancies) to find the closest match. As the database size grows, the computational burden of these comparisons becomes impractical.

The present invention describes a new approach based on machine learning techniques. The machine learns what features most efficiently and accurately represent a segment of content, even in the presence of a wide variety of possible distortions. Fewer data points are required to represent content; moreover, the frequency with which sample and reference material closely match is greatly increased. The approach reduces the computational complexity of a search, thereby allowing much larger libraries of content to be searched, and much greater numbers of simultaneous users to be supported.

### SUMMARY OF THE INVENTION

In one aspect of the invention, a system and method are configured to use convolutional neural nets (CNNs) for audio fingerprinting, enabling a fast and accurate method of audio fingerprinting.

In another aspect, a system and method are configured to sub-sample a neural net layer to reduce phase offset distortion, thereby reducing the number of fingerprints generated per unit time so as to reduce the computational complexity.

In another aspect, a system and method are configured to train a CNN for audio fingerprinting utilizing distorted and clean pairs of signal data. The resulting method is robust to various common ‘real world’ distortions.

In another aspect, a system and method are configured to aggregate audio fingerprint information over different timescales, such as for use in training a decision engine.

These and other aspects, features and advantages of the invention will be more fully understood with regard to the following detailed description and accompanying drawings.

### BRIEF DESCRIPTION OF THE DRAWINGS

FIG. 1 is a schematic high level architectural view of one embodiment of the invention using convolutional neural nets (CNNs) for audio fingerprinting;

FIG. 2 is a block diagram illustrating another embodiment of the invention for sub-sampling a neural net layer to reduce phase offset distortion;

FIG. 3 is a block diagram of another embodiment of a fingerprinting method according to the invention for training a CNN on distorted and clean pairs of signal data; and

FIG. 4 is a block diagram of another embodiment of the invention for providing a fingerprinting system that aggregates information over different timescales to reduce false positive probability over time.

### DETAILED DESCRIPTION OF CERTAIN EMBODIMENTS OF THE INVENTION

Various embodiments of the present invention are now described with reference to the drawings. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

The present invention may also be illustrated as a flow chart of a process of the invention. While, for the purposes of simplicity of explanation, the one or more methodologies shown therein, e.g., in the form of a flow chart, are described as a series of acts, it is to be understood and appreciated that the present invention is not limited by the order of acts, as some acts may, in accordance with the present invention, occur in a different order and/or concurrent with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the present invention.

Using Convolutional Neural Nets (CNNs) for Audio Fingerprinting

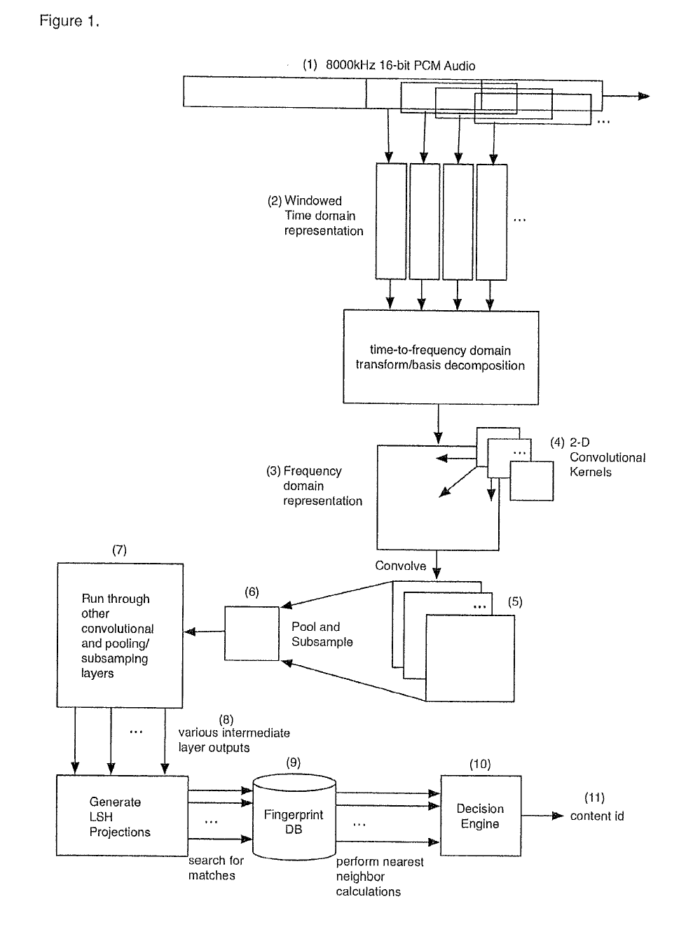

FIG. 1 illustrates an embodiment invention for providing fast and accurate audio fingerprinting.

FIG. 1 shows one example of a process of audio fingerprinting using convolutional neural nets (CNNs). The top of FIG. 1 shows incoming 8000 kHz, 16-bit PCM audio (1) from which overlapping windows (2) are taken and processed via a time-to-frequency transform, resulting in a frequency domain representation of each windowed segment (3). This representation may coincide with human perception via a perceptual nonlinear mapping (e.g. Mel or constant-Q warping) or may be the result of a simple, standard linear mapping (e.g. a Discrete Time Fourier Transform).

A set of two-dimensional kernels (4) is then convolved with the frequency domain representation, resulting in a set (with equal cardinality to the kernel set) of output representations (5). The convolution operations comprise what is commonly known as a convolutional layer in the literature.

Optionally, the convolutional layer output can then be passed through a pooling and subsampling stage (6) to produce either one or a set of representations with reduced dimensionality from the previous layer. The pooling and subsampling stage is commonly known as the pooling layer in the literature. The output representation(s) from the pooling layer may further be input into a set of alternating convolutional and pooling layers (7), with each set producing an output representation that has a lower dimensionality than its input representation.

Output representations at various stages of the CNN are extracted (8) and multiple projections are taken of each output representation (via a locality-sensitive hashing (LSH) algorithm) and used in a constant-order search for direct matches in a fingerprint database (9). The LSH algorithm employed will be appropriate for Euclidean distance and may incorporate principles from more sophisticated variants (e.g. multi-probe LSH).

The direct fingerprint database hash matches will be tested for similarity in the original CNN output space (i.e. before projections are taken) using a Euclidean distance measure and nearest neighbors will be delivered to a trained decision engine (10).

The trained decision engine will aggregate the nearest neighbors found over multiple timescales to output a decision, which either would be a specific content id or a decision of ‘no match’ (11).

Background discussion can be found in Y. LeCun, L. Bottou, Y. Bengio, and P. Haffner, “Gradient-based learning applied to document recognition,” Proceedings of the IEEE, 1998.

Using a Subsampling Neural Net Layer to Remove Phase Offset Distortion

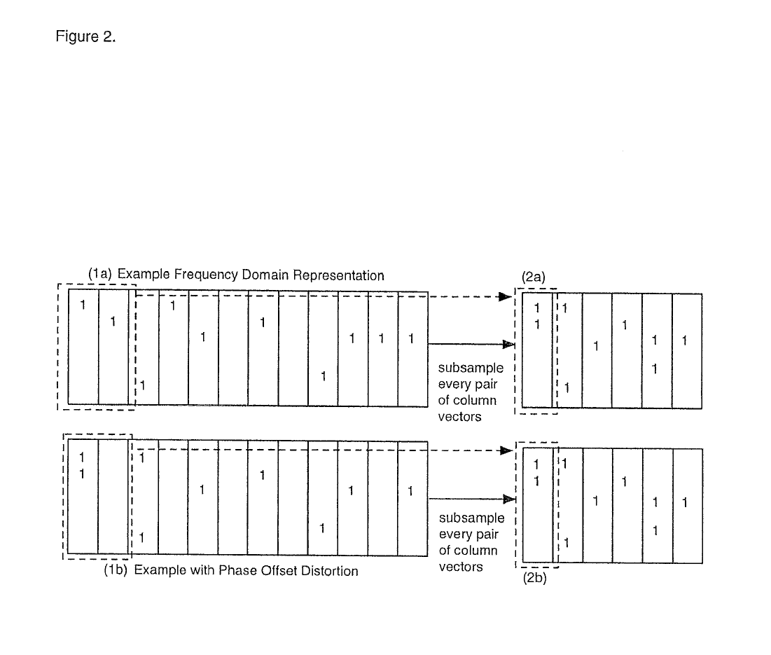

FIG. 2 illustrates an embodiment for developing a fingerprinting method that is robust to phase offset distortion in order to limit the number of fingerprints generated per unit time so as to reduce the computational complexity, suitable for audio fingerprinting.

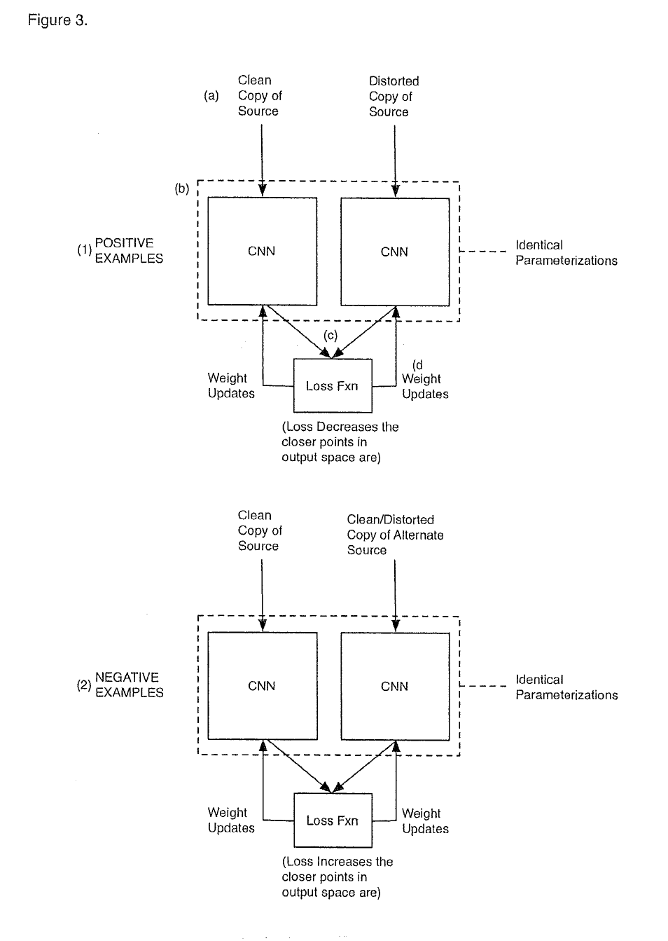

FIG. 2 shows one example of a subsampling process used to eliminate phase offset distortion. Once a frequency domain representation is produced (FIGS. 1, 3) by the fingerprinting system, an initial subsampling may be applied to this representation in order to smooth inconsistencies caused by phase offset distortion.

In FIG. 2, the frequency domain representation shown (1a) is a simplified binary matrix with ones at peak locations and zeros everywhere else. Phase offset inconsistencies between windowed time domain representations may result in these peaks shifting between columns in their frequency domain counterparts (1b). A simple subsampling process (e.g. taking the average or max over neighboring bins—as shown within the dotted boxes in FIG. 2) may be used to dampen the effects of phase offset distortion (2a,2b) resulting in equivalent or near-equivalent representations.

Background discussion can be found in Y. LeCun, L. Bottou, Y. Bengio, and P. Haffner, “Gradient-based learning applied to document recognition,” Proceedings of the IEEE, 1998.

Learning a Robust Feature Space by Training a Pairwise CNN on Distorted/Clean Pairs of Signal Data

FIG. 3 illustrates one embodiment of the invention for developing a fingerprinting method that is robust to various common ‘real world’ distortions, including additive white noise, spectral shaping due to the physical limitations of electromagnetic transformers, additive speech, and attenuation.

FIG. 3 shows one example of how to train a CNN for audio fingerprinting. The training process requires a pairwise CNN architecture (1b), where weights between CNNs are identical. One CNN is given a clean copy of source audio, while another is given a distorted copy of source audio (1a). The distortions applied to the distorted audio may be synthetically generated (e.g. by designing digital circuits that apply various distortions) or produced naturally (e.g. by passing a clean source through a speaker output in a noisy environment and recording the room response with a microphone).

The CNNs process the audio provided to them and pass their output representations to a contrastive loss function (1c).

The contrastive loss function produces a loss whose value influences weight updates in the pairwise CNN structure (1d).

Positive examples (where the source for both clean and distorted audio examples is the same content) produce lower losses the closer their CNN output representations are in space (1). Negative examples (where the sources for clean and distorted audio copies are different) produce lower losses the farther away their CNN output representations are in space (2).

Background discussion can be found in R. Iladsell, S. Chopra, and Y. LeCun, “Dimensionality Reduction by Learning an Invariant Mapping,” Proceedings of the TREE Computer Society Conference on Computer Vision and Pattern Recognition, 2006.

Multiscale Feature Aggregation using a Trained Decision Machine

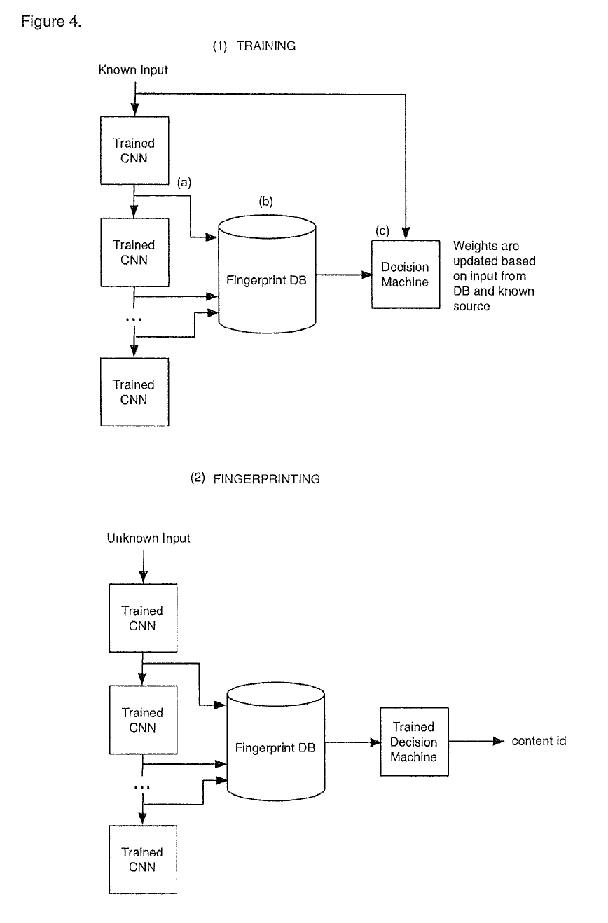

FIG. 4 illustrates one embodiment of the invention for providing a fingerprinting system that reduces its false positive probability over time integrating fingerprint information over numerous timescales.

FIG. 4 shows an example of how a decision machine can be trained to aggregate information over different timescales. During training (1), known audio content is passed through the trained CNN fingerprint system (see FIG. 1, Steps 1-8) and intermediate output representations (1a) are generated, passed through a LSH stage (implied as part of the trained CNN blocks in FIG. 4), and sent to the fingerprint DB (1b).

The fingerprint DB's matches are sent to a trainable decision machine (1c) along with the known correct content id and the machine parameters are updated in order to minimize the loss associated with choosing an incorrect match.

During fingerprinting (2), the trained decision machine is used to produce a content id for unknown content using the parameters that were learned in the training phase.

Background discussion can be found in G. Avancees, V. Rebuffel, and P. Bouthemy, “Motion detection robust to perturbations: A statistical regularization and temporal integration framework,” Proceedings on the International Conference on Computer Vision, 1993.

The foregoing methods and apparatus can be used in connection with a variety of computer-implemented systems. As one non-limiting example, the present invention can be utilized with the technology disclosed in U.S. patent application Ser. No. 13/621,277, filed Sep. 16, 2012, entitled “Second Screen Interactive Platform,” which is hereby incorporated by reference as if set forth in its entirety herein.

The previously described methods may be implemented in a suitable computing environment, e.g., in the context of computer-executable instructions that may run on one or more computers. In for example a distributed computing environment certain tasks are performed by remote processing devices that are linked through a communications network and program modules may be located in both local and remote memory storage devices.

A computer may include a processing unit, a system memory, and system bus, wherein the system bus couples the system components including, but not limited to, the system memory and the processing unit. A computer may further include disk drives and interfaces to external components. A variety of computer-readable media can be accessed by the computer and includes both volatile and nonvolatile media, removable and nonremovable media.

What has been described above includes examples of the present invention. It is, of course, not possible to describe every conceivable combination of components or methodologies for purposes of describing the present invention, but one of the ordinary skill in the art may recognize that many further combinations and permutations of the present invention are possible.

Accordingly, the present invention is intended to embrace all such alterations, modifications and variations that fall within the present disclosure and/or claims. Furthermore, to the extent that the term “includes” is used in either the detailed description or the claims, such term is intended to be inclusive in a manner similar to the term “comprising” when employed as a transitional word in a U.S. claim.

What is claimed is:

1. A apparatus for fingerprinting an audio signal, comprising:
a processor;
a storage medium accessible by the processor;
one or more software modules encoded on the storage medium (i) which execute in the processor which, when executed by the processor, cause the apparatus to:
identify overlapping windows in a time domain representation of the audio signal;
establish a frequency domain representation of the overlapping windows;
convolve a set of two-dimensional kernels with the frequency domain representation to thereby provide a convolutional layer as an output stage;
reduce dimensionality of the convolution layer to provide one or more further output stages; and
process the output stages so as to output a decision in regard to a plurality of the overlapping windows comprising either a specific content id that matches to the audio signal or a failure-to-match indication.

2. A apparatus for fingerprinting an audio signal, comprising:
a processor;
a storage medium accessible by the processor;
one or more software modules encoded on the storage medium (i) which execute in the processor which, when executed by the processor, cause the apparatus to:
identify overlapping windows in a time domain representation of the audio signal;
establish a frequency domain representation of the overlapping windows;
convolve a set of two-dimensional kernels with the frequency domain representation to thereby provide a convolutional layer as an output stage;
reduce dimensionality of the convolution layer using at least one pooling layer, at least one further convolutional layer, or an alternating set of pooling and further convolutional layers to provide one or more further output stages;
extract Euclidian projections from several of the output stages;
search an audio fingerprint database for a match of the projections;
forward selected matches to a trained decision engine; and
output a decision in regard to a plurality of the overlapping windows comprising either a specific content id that matches to the audio signal or a failure-to-match indication.
